(19) United States
(12) Patent Application Publication
(10) Pub. No.: US 2014/0352527 A1
(43) Pub. Date: Dec. 4, 2014

(54) Anti-Rotation Apparatus for Linear Actuator

(71) Applicant: Zaytran, Inc., Elyria, OH (US)

(72) Inventors: Theodore Stanley Zajac, Avon Lake, OH (US); Steven Eric Wallace, Sheffield Lake, OH (US); Cory David Trent, Elyria, OH (US)

(73) Assignee: Zaytran, Inc., Elyria, OH (US)

(21) Appl. No.: 13/903,059

(22) Filed: May 28, 2013

(51) Int. Cl. F15B 15/02

(52) U.S. Cl. CPC F15B 15/02
USPC 92/172

(57) ABSTRACT

A linear actuator has a housing with a bore therethrough, thus defining an axis. A shaft is in sliding engagement with a portion of the bore and a piston is coupled to the shaft. An anti-rotation apparatus has an elongate slot defined in the housing which extends parallel to the axis. The elongate slot has opposing sidewalls that are non-parallel to one another and offset from a plane perpendicular to the axis by a respective predetermined angle ranging between zero and fifteen degrees. A bearing block has opposing sides and a hole therethrough, wherein an attachment member extends through the hole, coupling the bearing block to the shaft. The opposing sides of the bearing block are parallel to the respective opposing sidewalls of the elongate slot. The attachment member provides a selective engagement force between the opposing sides of the bearing block and the opposing sidewalls of the elongate slot. The opposing sides of the bearing block respectively slidingly engage the opposing sidewalls of the elongate slot, therein generally preventing a rotation of the shaft about the axis.

### FIELD

The present invention relates generally to linear actuators, and more particularly to a linear actuator having a trapezoidal bearing block operably coupled between a shaft and housing for preventing rotation of the shaft relative to the housing.

### BACKGROUND

In many manufacturing processes, individual sheet metal components are fabricated with locating holes. Locating pins extend through these holes to hold two or more sheet metal components in position relative to each other and to the resultant sheet metal assembly during welding processes. Accordingly, accurate positioning of the locating pins is typically necessary to ensure consistency in the sheet metal assembly.

Stationary locating pins may be fixed to a frame of the associated manufacturing equipment for locating the individual sheet metal components. However, in many manufacturing situations, the locating pins must be retracted from the completed sheet metal assembly so that it can progress to the next operation. In order to retract the locating pin(s), the locating pin(s) are often mounted on a linear actuator.

A linear actuator typically comprises a housing which defines an internal bore and a piston-rod assembly which moves within the internal bore in response to fluid pressure. One end of the rod is attached to the piston, and the other end of the rod extends beyond the housing, wherein pilot holes, flats and/or threaded passages are provided on the rod for securing a locating pin thereto.

During locating and/or welding processes, it is often important that the piston-rod assembly not rotate relative to the housing. Such non-rotation is important for ensuring that the working position of the locating pin is reliable and repeatable. For example, over repeated use, wear may occur on the locating pin, wherein the wear is associated with a particular area of the sheet metal component(s). If the locating pin were to be permitted to rotate with respect to the housing of the linear actuator, the locating pin could wear unequally, and the resulting positioning of the sheet metal component(s) can vary based on the rotational position of the locating pin. Further, rotational issues are magnified when it is necessary for a locating pin to be attached to an actuator with an offset, wherein the offset allows the locating pin to fit or be actuated around another part of the equipment during sheet metal working operations.

One technique traditionally used to prevent rotation of a piston-rod assembly in a linear actuator is to provide the rod with a corresponding bearing surface of the internal bore having a rotation-preventing cross-sectional geometry. For example, the rod/bearing surface can be fabricated having a square cross-sectional geometry.

One common example is illustrated in FIG. 1, wherein a conventional linear actuator 10 is provided having a square shaft 15 that extends and retracts with respect to a housing 20 for positioning a workpiece (not shown). The housing 20, is provided with a square bore 25, wherein the square bore, in conjunction with a sacrificial square bearing 30, guides the shaft 15 throughout its extension and retraction, while generally preventing rotation of the shaft. The sacrificial square bearing 30 is typically comprised of a material that is substantially softer than the square shaft 15, thus allowing the square bearing to wear more quickly than the typically more-expensive square shaft.

However, such polygonal arrangements are difficult to fabricate, in that consistently matching the square bearing 30 to a square shaft 15 in a high production environment is technically challenging and/or expensive to achieve. Further, even if fabrication issues are ignored, such polygonal arrangements tend to present wear problems. Specifically, whenever torque is applied to the square shaft 15 (such as from an offset locating pin) the four corners 35 of the shaft will continuously contact the bearing surface 40, thereby making these minimal areas of the shaft highly susceptible to wear. Furthermore, replacement of the worn parts typically requires disassembly of the housing components, disassembly of the piston-rod assembly, and/or replacement of the entire rod, thus deleteriously affecting production and costs associated with the linear actuator.

Another rotation-preventing technique used to prevent rotation of the piston-rod assembly in a linear actuator is to provide a round anti-rotation member coupled to the rod with a corresponding bearing slot defined in the housing, wherein the anti-rotation member travels within the slot, therein preventing rotation of the piston-rod assembly with respect to the housing. However, the inventors appreciate that wear can still occur on either of the anti-rotation member and/or slot, therein necessitating removal and replacement of the anti-rotation member and/or housing.

### SUMMARY

The present invention overcomes the limitations of the prior art by providing a robust linear actuator operable to provide consistent positioning of workpieces Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present disclosure is generally directed toward a linear actuator having a robust anti-rotation mechanism. The linear actuator comprises a housing having a bore therethrough, therein defining an axis. A shaft is in sliding engagement with at least a first portion of the bore, wherein a piston is further coupled to the shaft. The first portion of the bore, for example, has a circular cross-section when viewed along the axis. The piston is in further sliding engagement with a second portion of the bore.

In accordance with one exemplary aspect, a novel anti-rotation apparatus is provided, wherein the anti-rotation apparatus comprises an elongate slot defined in the housing and a bearing block coupled to the shaft via an attachment member. The elongate slot, for example, is axially offset from the bore. Opposing sidewalls of the elongate slot extend parallel to the axis, wherein the opposing sidewalls are generally V-shaped when viewed along the axis. Opposing sides of the bearing block are further generally V-shaped when viewed along the axis, wherein the opposing sides of the bearing block respectively slidingly engage the opposing sidewalls of the elongate slot. The sliding engagement between the opposing sides of the bearing block and opposing sidewalls of the elongate slot therein generally prevent a rotation of the shaft about the axis.

According to one example, the bearing block has a trapezoidal geometry when viewed along the axis, wherein the opposing sides of the bearing block are respectively offset from a plane perpendicular to the axis by a respective predetermined angle. Further, the opposing sidewalls of the elongate slot are respectively offset from the plane perpendicular to the axis by the same respective predetermined angle. In one example, the opposing sides of the bearing block are equally offset from the plane perpendicular to the axis. Alternatively, the respective predetermined angle can differ between the opposing sides of the bearing block. In another example, the respective predetermined angle is selected from a range between zero and fifteen degrees from the plane perpendicular to the axis.

The bearing block, for example, is formed as an extrusion, wherein the extrusion generally defines the opposing sides of the bearing block. As such, efficiencies in manufacturing of the bearing block can be achieved over other methods, as the respective predetermined angles of the opposing sides of the bearing block can be closely, yet inexpensively maintained.

In accordance with another aspect, the anti-rotation apparatus, for example, can further comprise one or more friction-reducing coatings disposed on one or more of the opposing sides of the bearing block and the opposing sidewalls of the elongate slot. In one example, the one or more friction-reducing coatings comprise an electroless nickel coating formed on the opposing sides of the bearing block. In other examples, the one or more friction-reducing coatings comprise one or more of grease, oil, graphite, and an ultra-high molecular weight film.

The bearing block, for example, further comprises a hole extending generally perpendicular to the axis, wherein the attachment member is configured to extend through the hole and to selectively couple the bearing block to the shaft. In one example, the shaft comprises a threaded hole extending generally perpendicular to the axis into the shaft. Accordingly, the attachment member comprises a bolt having a head and a threaded portion, wherein the threaded portion of the bolt threadingly engages the threaded hole in the shaft. As such, the head of the bolt forces the bearing block toward the shaft, therein engaging the opposing sides of the bearing block with the opposing sidewalls of the elongate slot. The attachment member, for example, provides a selective engagement force between the opposing sides of the bearing block and the opposing sidewalls of the elongate slot.

In yet another example, a sensor assembly is provided, wherein the sensor assembly is configured to sense a position of the anti-rotation apparatus along the axis.

Thus, to the accomplishment of the foregoing and related ends, the disclosure comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a conventional linear actuator having a square shaft anti-rotation mechanism.

FIG. 2 illustrates a perspective view of an exemplary linear actuator having an anti-rotation apparatus according to one aspect.

FIG. 3 illustrates a cross-sectional view of an exemplary linear actuator according to another aspect.

FIG. 4 illustrates a cross-sectional view of an exemplary elongate slot in a housing of the linear actuator of FIG. 2 according to another aspect.

FIG. 5 illustrates a perspective view of an exemplary bearing block in accordance with yet another exemplary aspect.

FIG. 6 illustrates a cross-sectional view of an exemplary bearing block in accordance with another exemplary aspect.

FIG. 7 illustrates a cross-sectional view of another exemplary bearing block in accordance with yet another exemplary aspect.

FIG. 8 illustrates a cross-sectional view of an assembled anti-rotation apparatus according to the still another aspect.

FIG. 9 illustrates a front perspective view from an end of a shaft of the linear actuator of FIG. 2 in accordance with various aspects.

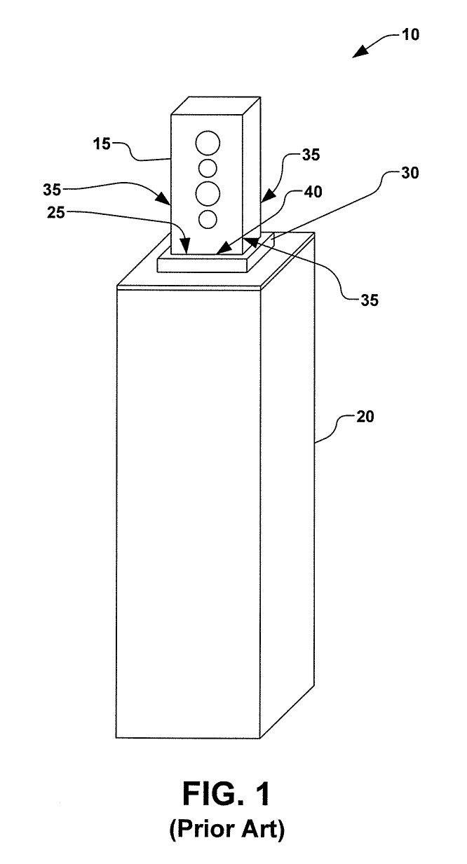

### DETAILED DESCRIPTION

The present disclosure will be described with reference to the drawings wherein like reference numerals are used to refer to like elements throughout. It should be understood that the description of these aspects are merely illustrative and that they should not be taken in a limiting sense. In the following description, for purposes of explanation, numerous specific details are set forth in order to provide a thorough understanding of the present disclosure. It will be evident to one skilled in the art, however, that the present disclosure may be practiced without these specific details. In other instances, well-known structures and devices are shown in block diagram form in order to facilitate description of the present disclosure.

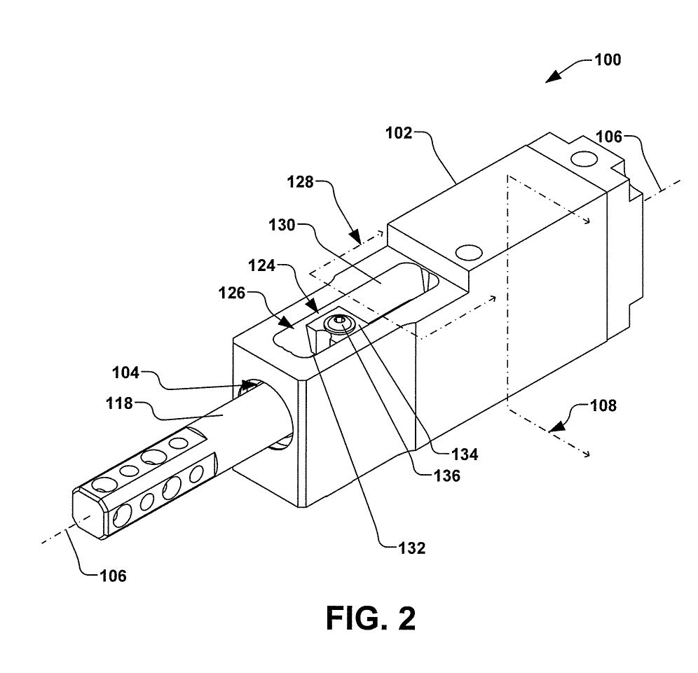

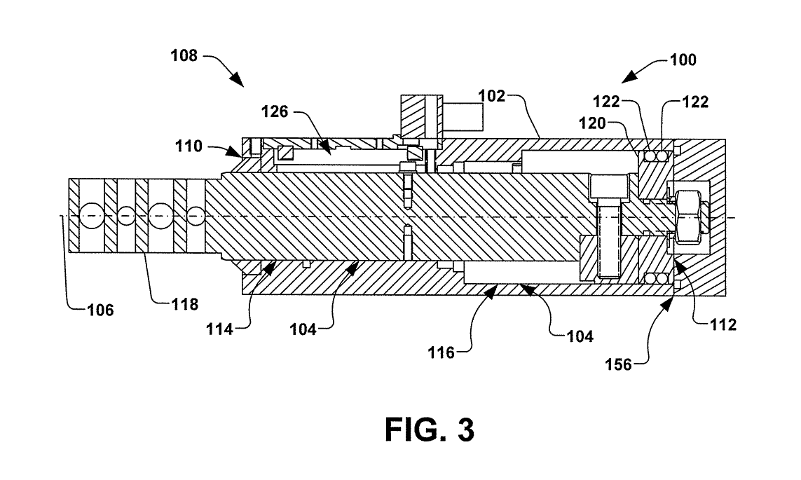

Referring now to the Figures, in accordance with the present disclosure, FIG. 2 illustrates a perspective view of an exemplary linear actuator 100. The linear actuator 100 comprises a housing 102 having a bore 104 extending therethrough, therein defining an axis 106. The housing 102 of FIG. 2 is further illustrated in cross-section 108 in FIG. 3. The bore 104, as shown in FIG. 3, for example, extends from a first end 110 of the housing 102 to a second end 112 of the housing, wherein the housing in the present example is generally contiguous (e.g., formed from a contiguous block of metal). In the present example, the bore 102 comprises at least a first portion 114 associated with the first end 110 of the housing 102 and a second portion 116 associated with the second end 112 of the housing.

In accordance with one exemplary aspect, a shaft 118 illustrated in FIGS. 2 and 3 in sliding engagement with at least the first portion 114 of the bore 104. In one example, a cross-sectional profile of the shaft 118 and first portion 114 of the bore 104 are circular, however other shapes, such as polygonal or ovular are also contemplated. A piston 120 is further coupled to the shaft 118, wherein the piston is in sliding engagement with the second portion 116 of the bore 104. The piston 120, for example, may have one or more sealing members 122 (e.g., one or more o-rings) associated therewith, wherein a fluid pressure associated with a gas or liquid applied to either side of the piston 120 causes the piston to move within the bore 104, therein linearly translating the shaft 118 along the axis 106, as will be understood by one of ordinary skill in the art. The piston 120, for example, can be circular when viewed from the axis 106, or another shape, such as polygonal with substantially rounded corners.

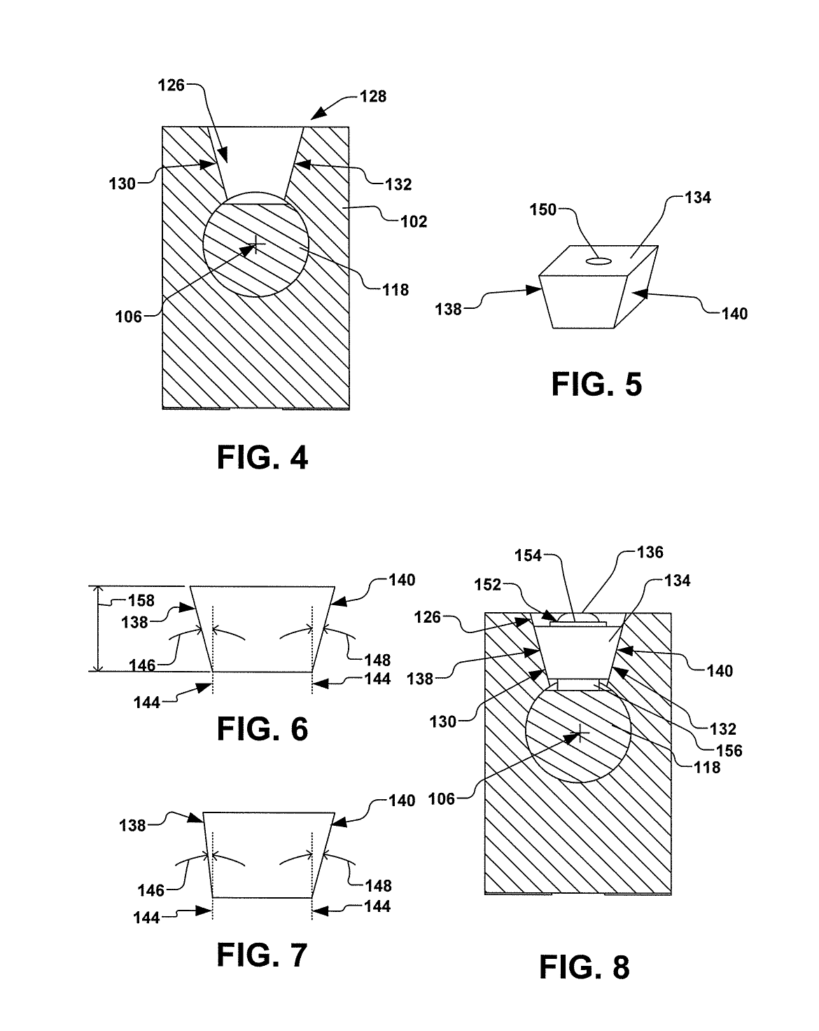

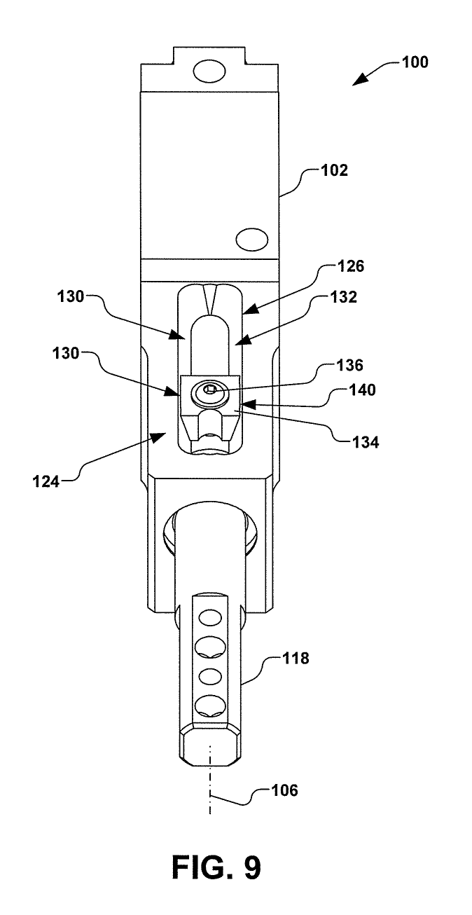

Referring to FIGS. 2 and 9, in accordance with the disclosure, the linear actuator 100 further comprises an anti-rotation apparatus 124. The anti-rotation apparatus 124, for example, generally prevents the shaft 118 from rotating about the axis 106 with respect to the housing 102. The anti-rotation apparatus 124, for example, comprises an elongate slot 126 defined in the housing 102. The elongate slot 126, for example, may be axially offset from the bore 104. FIG. 4 further illustrates a cross-sectional view 128 of the housing 102 when viewed along the axis 106, wherein opposing sidewalls 130, 132 of the elongate slot 126 are illustrated. The opposing sidewalls 130, 132 of the elongate slot 126, for example, extend generally parallel to the axis 106. The opposing sidewalls 130, 132 in the present example are generally wedge-shaped or V-shaped when viewed along the axis 106.

In accordance with the disclosure, the anti-rotation apparatus 124 further comprises , a bearing block 134 operably coupled to the shaft 118 via an attachment member 136, wherein, as illustrated in FIGS. 2, 8 and 9, the bearing block has opposing sides 138, 140 that are generally complimentary to the opposing sidewalls 130, 132 of the elongate slot 126. For example, the opposing sides 138, 140 of the bearing block 134 are generally wedge-shaped or V-shaped when viewed along the axis 106, as illustrated in FIGS. 5-8m wherein the opposing sides of the bearing block respectively slidingly engage the opposing sidewalls 130, 132 of the elongate slot 126. Accordingly, the sliding engagement between the opposing sides 138, 140 of the bearing block 134 and the opposing sidewalls 130, 132 of the elongate slot 126 generally prevents a rotation of the shaft 118 about the axis 106, as illustrated in FIGS. 2, 8 and 9.

In the example illustrated in FIGS. 5-8, the bearing block 134 has a trapezoidal geometry when viewed along the axis 106 of FIG. 2. For example, the opposing sides 138, 140 of the bearing block 134 of FIG. 6 are offset from a plane 144 that runs perpendicular to the axis 106 by a respective predetermined angle 146, 148. Accordingly, the opposing sidewalls 130, 132 of the elongate slot 126 of FIG. 8 are further respectively offset from the plane 144 perpendicular to the axis 106 by the respective predetermined angle 146, 148. In one example, the opposing sides 138, 140 of the bearing block 134 (and opposing sidewalls 130, 132 of the elongate slot 126) are equally offset from the plane 144 (e.g., the predetermined angles 146 and 148 are equal). Alternatively, as illustrated in FIG. 7, the predetermined angle 146 differs from the predetermine angle 148. In one example, the respective predetermined angle 146, 148 is selected from a range between zero and fifteen degrees from the plane 144 perpendicular to the axis 106.

In accordance with another example, as illustrated in FIG. 5, the bearing block 134 comprises a hole 150 extending generally perpendicular to the axis 106 of FIG. 2, wherein the attachment member 136 extends through the hole and couples the bearing block to the shaft 118, as illustrated in FIG. 8. In one example, the shaft 118 comprises a threaded hole (not shown) extending generally perpendicular to the axis 106 into the shaft. In this example, the attachment member 136 comprises a bolt 152 having a head 154 and a threaded portion 156, wherein the threaded portion of the bolt threadingly engages the threaded hole in the shaft. Accordingly, the head 154 of the bolt 152 forces the bearing block 134 toward the shaft 118, therein engaging the opposing sides 138, 140 of the bearing block with the opposing sidewalls 130, 132 of the elongate slot 126.

The attachment member 136, for example, provides a selective engagement force between the opposing sides 138, 140 of the bearing block 134 and the opposing sidewalls 130, 132 of the elongate slot 126. The engagement force, for example, can be adjusted based on desired anti-rotation of the shaft 118. Further, should the bearing block 134 be subject to significant wear, the attachment member 136 can be advantageously tightened, therein re-establishing the desired engagement force. The bearing block 134 may be further selectively removably coupled to the shaft 118 via the attachment member 136, wherein the bearing block may be inspected, replaced, or otherwise removed.

The bearing block 134 of the anti-rotation apparatus 124 of FIG. 2, for example, may be easily accessed, inspected, repaired and/or replaced without disassembly of the piston 120 of FIG. 3, housing assembly 156, and/or without replacement of various other piston-rod components. In this manner, the bearing block 134 may be replaced by simply unscrewing the attachment member 136, removing the used bearing block, placing the new bearing block in the elongate slot 126, and screwing the attachment member back into the shaft 118.

In one example, the bearing block 134 is formed as an extrusion, wherein the extrusion generally defines the opposing sides 138, 140 of the bearing block. Since angular surfaces (e.g., the opposing sides 138, 140 of the bearing block) can be produced accurately and inexpensively via extrusion, cost savings can be attained over conventional machining. Furthermore, since the angular orientation of the opposing sides 138, 140 is the only dimension needing relative precision, a height 158 of the bearing block can vary and is non-critical, as the height can be compensated for via the attachment member 136.

According to yet another exemplary aspect, the anti-rotation apparatus 124 of FIG. 2 further comprises one or more friction-reducing coatings (not shown) disposed on one or more of the opposing sides 138, 140 of the bearing block 134 and the opposing sidewalls 130, 132 of the elongate slot 126. The one or more friction-reducing coatings, for example, may comprise an electroless nickel coating formed on the opposing sides 138, 140 of the bearing block 134. Alternatively, or in addition, the one or more friction-reducing coatings comprise one or more of grease, oil, graphite, and ultra-high molecular weight (UHMW) film or tape or other friction-reducing coatings, lubricants, or materials.

In accordance with still another example, the linear actuator 100 further comprise a sensor assembly 160, as illustrated in FIG. 3. The sensor assembly 160, for example, is configured to sense a position of the anti-rotation apparatus 124 (e.g., the one or more of the bearing block 134 and attachment member 136) along the axis 106. The sensor assembly 160, for example, is configured to generate signals when the shaft 118 is at certain position(s), wherein the anti-rotation apparatus 124 may incorporate various components of the sensing assembly to determine the position(s).

Accordingly, the present disclosure provides a linear actuator having a robust anti-rotation mechanism, wherein the anti-rotation mechanism provides accurate positioning of the shaft. Further, the anti-rotation mechanism can be inexpensively implemented, and inspection and replacement of the various components associated therewith can be readily performed. Previous rotation-preventing techniques involving a round anti-rotation member coupled to a shaft with a corresponding bearing slot defined in the housing lead to significant wear on either of the anti-rotation member and/or slot, therein necessitating removal and replacement of the anti-rotation member and/or housing. The present disclosure advantageously provides an anti-rotation apparatus 124 wherein the bearing block 134 can be simply tightened against the elongate slot 126 via the attachment member 136, should the bearing block experience wear. Thus, the present invention provides a significant advantage over previous linear actuators, as the need to remove and replace of anti-rotation components is significantly reduced.

Although the disclosure has been shown and described with respect to certain aspects, equivalent alterations and modifications will occur to others skilled in the art upon the reading and understanding of this specification and the annexed drawings. In particular regard to the various functions performed by the above described components (systems, devices, assemblies, etc.), the terms used to describe such components are intended to correspond, unless otherwise indicated, to any component which performs the specified function of the described component (i.e., that is functionally equivalent), even though not structurally equivalent to the disclosed structure that performs the function in the herein illustrated exemplary aspects of the disclosure. In addition, while a particular feature of the invention may have been disclosed with respect to only one of several aspects, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

What is claimed:

1. A linear actuator, comprising:
a housing having a bore therethrough, therein defining an axis;
a shaft in sliding engagement with at least a first portion of the bore;
a piston coupled to the shaft, wherein the piston is in sliding engagement with a second portion of the bore; and
an anti-rotation apparatus, wherein the anti-rotation apparatus comprises:
an elongate slot defined in the housing, wherein opposing sidewalls of the elongate slot extend parallel to the axis, and wherein the opposing sidewalls are generally V-shaped when viewed along the axis;
an attachment member; and
a bearing block coupled to the shaft via the attachment member, wherein opposing sides of the bearing block are generally V-shaped when viewed along the axis, and wherein the opposing sides of the bearing block respectively slidingly engage the opposing sidewalls of the elongate slot, therein generally preventing a rotation of the shaft about the axis.

2. The linear actuator of claim 1, wherein the first portion of the bore has a circular cross-section when viewed along the axis.

3. The linear actuator of claim 1, wherein the bearing block has a trapezoidal geometry when viewed along the axis.

4. The linear actuator of claim 3, wherein the opposing sides of the bearing block are respectively offset from a plane perpendicular to the axis by a respective predetermined angle.

5. The linear actuator of claim 4, wherein the opposing sidewalls of the elongate slot are respectively offset from the plane perpendicular to the axis by the respective predetermined angle.

6. The linear actuator of claim 4, wherein the opposing sides of the bearing block are equally offset from the plane perpendicular to the axis.

7. The linear actuator of claim 4, wherein the respective predetermined angle is selected from a range between zero and fifteen degrees from the plane perpendicular to the axis.

8. The linear actuator of claim 1, wherein the bearing block comprises a hole extending generally perpendicular to the axis, and wherein the attachment member extends through the hole and couples the bearing block to the shaft.

9. The linear actuator of claim 8, wherein the shaft comprises a threaded hole extending generally perpendicular to the axis into the shaft, and wherein the attachment member comprises a bolt having a head and a threaded portion, wherein the threaded portion of the bolt threadingly engages the threaded hole in the shaft, and wherein the head of the bolt forces the bearing block toward the shaft, therein engaging the opposing sides of the bearing block with the opposing sidewalls of the elongate slot.

10. The linear actuator of claim 8, wherein the bearing block is selectively removably coupled to the shaft via the attachment member.

11. The linear actuator of claim 10, wherein the attachment member provides a selective engagement force between the opposing sides of the bearing block and the opposing sidewalls of the elongate slot.

12. The linear actuator of claim 1, further comprising a sensor assembly, wherein the sensor assembly is configured to sense a position of the anti-rotation apparatus along the axis.

13. The linear actuator of claim 1, wherein the elongate slot is axially offset from the bore.

14. The linear actuator of claim 1, wherein the bearing block is comprised of an extrusion, wherein the extrusion generally defines the opposing sides of the bearing block.

15. The linear actuator of claim 1, wherein the anti-rotation apparatus further comprises one or more friction-reducing coatings disposed on one or more of the opposing sides of the bearing block and the opposing sidewalls of the elongate slot.

16. The linear actuator of claim 15, wherein the one or more friction-reducing coatings comprise an electroless nickel coating formed on the opposing sides of the bearing block.

17. The linear actuator of claim 15, wherein the one or more friction-reducing coatings comprise one or more of grease, oil, graphite, and an ultra-high molecular weight film.

18. A linear actuator, comprising:
a housing having a bore therethrough, therein defining an axis;
a shaft in sliding engagement with at least a first portion of the bore;
a piston coupled to the shaft, wherein the piston is in sliding engagement with a second portion of the bore; and
an anti-rotation apparatus, wherein the anti-rotation apparatus comprises:
an elongate slot defined in the housing and extending parallel to the axis, wherein the elongate slot comprises opposing sidewalls that are non-parallel to one another and offset from a plane perpendicular to the axis by a respective predetermined angle ranging between zero and fifteen degrees;
an attachment member; and
a bearing block having opposing sides and a hole therethrough, wherein the attachment member extends through the hole and couples the bearing block to the shaft, and wherein the opposing sides of the bearing block are parallel to the respective opposing sidewalls of the elongate slot, and wherein the attachment member provides a selective engagement force between the opposing sides of the bearing block and the opposing sidewalls of the elongate slot, wherein the opposing sides of the bearing block respectively slidingly engage the opposing sidewalls of the elongate slot, therein generally preventing a rotation of the shaft about the axis.

19. The linear actuator of claim 18, wherein the anti-rotation apparatus further comprises one or more friction-reducing coatings disposed on one or more of the opposing sides of the bearing block and the opposing sidewalls of the elongate slot, and wherein the one or more friction-reducing coatings comprise one or more of grease, oil, graphite, an ultra-high molecular weight film, and an electroless nickel coating.

20. The linear actuator of claim 18, wherein the opposing sides of the bearing block are equally offset from the plane perpendicular to the axis.
